(19) United States
(12) Patent Application Publication
(10) Pub. No.: US 2006/0212374 A1
(43) Pub. Date: Sep. 21, 2006

(54) Shari'ah (Islamic) compliant financial services card

(76) Inventor: Joanne Marlowe-Noren, Wadsworth, IL (US)

Correspondence Address: Paul E. Schaafsma;NovusIP, LLC, Suite 221, 521 West Superior, Chicago, IL, 60610, US

(21) Appl. No.: 11/083,844

(22) Filed: Mar. 18, 2005

(51) Int. Cl. G06Q 40/00

(52) U.S. Cl. 705/35

(57) ABSTRACT

A financial services card formulated in accordance with the principles of the present invention comprises a payment or transactional card equivalent in many practical respects to a conventional credit card, however, which operates in compliance with Shari'ah financial guidelines and Islamic law and therefore is conducive for use by Islamic consumers in support of their respective purchase or payment applications. This financial services card can include processing and transaction acquisition practices which are compatible and consistent with the operating morays and norms of the conventional credit card industry while complying with Shari'ah financial guidelines.

### FIELD OF THE INVENTION

The present invention relates to consumer-based Shari'ah (Islamic) compliant financial products and transactional payment cards.

### BACKGROUND OF THE INVENTION

Historically, the Islamic versus non-Islamic financial market practices and philosophies have operated as wholly independent and virtually unrelated financial systems for hundreds if not thousand of years. In Islamic economies, Shari'ah investment principles and religious guidelines are applied and practiced which are clearly understood by Islamic institutions and practicing Muslims. Shari'ah investment principles and religious guidelines refer to Islamic law related to financial and investment matters within a predominantly Islamic or Muslim community. Today, however, in a world that is closely tied by high-speed communications, global market and financial coordination, and a general move toward non-cash or electronically initiated payment transactions, the ability for these two financial systems to continue to operate efficiently as independently functioning bodies is becoming less and less likely. On the macro-economic institutional level the need for compatibility of the two systems speaks to the need for the creation of new types of investment units and asset classes that are not only Shari'ah compliant, but also are compatible with conventional market norms. In the consumer or retail marketplace, fiscal compatibility and functionality speaks to the need to find ways in which Muslim consumers can enjoy the same consumer conveniences at their local banks, in their bill-paying practices, and in their cash management philosophies as conventional consumers have been able to enjoy for the last thirty years or more.

In today's global village, many consumers who adhere to Shari'ah law by observing Shari'ah investment and financial principles and guidelines reside in large numbers in geographic areas that do not observe fiscal practices that are consistent with Shari'ah law. Although in the context of a community in which Muslims represent a minority, compliance with Shari'ah law appears more of a consumer elected restriction rather than a strict edict of law, the significance of such an elective restriction cannot be underestimated as to the role it plays in consumer decisions in the Islamic populous. Because of their core beliefs, in many cases these consumers do not enjoy basic financial conveniences such as the use of conventional credit cards for travel or consumer purchases because such conveniences require, among other prohibited practices, both the payment and collection of interest, or riba, in their foundational operation. Riba is the forbidden profit referenced in the Holy Quran that is most comparable to interest in a conventional loan of money. To date, banks and credit card issuers have not yet meaningfully found a way to reconcile the restrictive practices extrapolated from the Holy Quran with conventional credit practices as are customarily used in most other mature sectors of the global economic marketplace.

Because of these shortcomings of conventional banking and credit card functionalities, many Islamic consumers refuse to utilize most major credit cards, thereby denying those consumers many of the lifestyle conveniences inherent with using such financial products and services. This produces an environment in which the financial interests of those in the Muslim communities are left under-serviced when it comes to basic credit or financial services card use which conventional market consumers have long taken for granted. Thus, many Islamic consumers, in an effort to perform the simplest of functions—renting a car, paying for a hotel, purchasing an airline ticket—must do one of three things: acquire one of the few financial service cards in the market that do not charge monthly interest in the event the entire balance is paid off monthly (which arguably can still fail to satisfy restrictions against riba since interest and late charges are still a component of the card's operation); utilize a debit card or check card; or utilize a conventional credit card out of necessity and accept the violation of Shari'ah principle as necessary. The first two of these three are simply not practicable unless the consumer has ready cash available as both of these solutions require that the consumer have funds sufficient to pay for whatever transaction in which he or she is engaging. The third solution is the conventional markets response to a need, but a violation of a philosophical conviction of a Muslim. This practice is, at best, unattractive to the Islamic community and to some in the community viewed as completely impermissible.

It would thus be desirable to create a standardized financial model that delivers certain financial services to the Islamic consumer in a manner comparable to the conventions of traditional credit card practices, but that is designed to take into account the very real religious concerns of Muslim consumers. It is thus desirable to create a standardized financial model that is adaptable by banks and other issuers within the conventional banking marketplace that will cater to the specialized needs of the Islamic consumer in the delivery of certain financial services and functions that are of an equivalency to the granting of revolving credit lines via conventional credit cards. In this way, an Islamic consumer may make purchases utilizing a Shari'ah compliant financial services card with the same ease as conventional consumers utilize traditional credit cards. This is a significant financial service opportunity in that the Islamic consumers who are, under present circumstances and practices, disinclined to utilize conventional credit cards could for the first time leverage their good financial standing into additional consumer buying power.

The advent of a Shari'ah compliant financial services card, on a merchant level, can be designed to embody the same ease of processing, acceptance efficiencies, and cost structures as conventional credit cards. Aside from differences in perhaps issuer branding or consumer brand identity, the merchant will engage in virtually the same acceptance process as that which is the norm for conventional credit cards, making the effective assimilation of this type of financial services card largely comparable to what present practices permit. Such ease in merchant absorption more readily enables the commencement of a retail-based fiscal convenience to the Islamic consumer body who to date has been largely ignored. The primary difference between the conventional credit card and the Shari'ah compliant financial services card would be found in an analysis of the differences in the issuer's card processing, administrative practices, and billings. The financial services card would be issued under a strict set of operating guidelines that take into primary consideration the sensitivities of the Islamic world in administration, consumer cost structures, and pricing. Thus, the Islamic consumer can enjoy the conveniences of traditional credit card functionalities assured of the religious propriety of their actions due to the implementation of operating structures and practices that reflect the religious views of Islam.

Additionally, with the introduction of a Shari'ah compliant financial services card that not only affords convenience, but also makes additional funds available for direction and use at the discretion of the consumer, consumer-spending habits within the Islamic community can be anticipated to increase. For the first time, these consumers would have the option to spend money this month in anticipation of carrying it forward and repaying it up to several months later without violating their moral and religious convictions.

In the conventional consumer financial markets, this type of credit balance carry is common practice. It has been achieved and accommodated in a variety of consumer-friendly ways which, however, call for in some part the payment of consideration to the card issuer in the form of interest. As such, the vast majority of these conventional credit vehicles do not comply with Shari'ah guidelines and are therefore disqualified from use by a consumer who subscribes and abides by Islamic principles with regard to financial matters. Thus, a new approach to meeting this need within the Islamic consumer sector is clearly needed.

In addition, a lack of understanding by the credit card issuers of the widespread scope and practical need for such a specifically designed financial services vehicle within the global Islamic community has hindered the creation and implementation of a universally accepted Shari'ah compliant financial services card. This market opportunity, although known to be of interest within the Islamic community itself, has remained relatively unidentified by the most likely conventional institutions to invest in and fiscally benefit from the financial engineering and design of a Shari'ah compliant financial services card.

The need for this type of Shari'ah compliant financial services card is undeniably indicated when considering the breadth and reach of Islam. The creation of this type of vehicle is critical and elementary to leveling the metaphorical playing field between conventional credit card users and Islamic consumers who would otherwise be excluded from these type of financial services. If this type of financial services card were made available with financial tendencies that made it comparable to conventional credit card practices and costs, even those practicing Islamic consumers who had reconciled themselves to using conventional credit cards would likely switch to a Shari'ah compliant financial services card in order to bring their fiscal practices into better and truer alignment with the teachings drawn from the Holy Quran. To date, such an option has not been availed to the Islamic consumer segment, and the creation of such a vehicle would likely expand the present day market for credit card-like products and services in the global Islamic consumer marketplace.

What is thus needed is a Shari'ah compliant financial services card that is supported by a business process and financial services administrative methodology to permit its issuance and use in a manner consistent with conventional credit cards, while doing so in a manner consistent with Shari'ah financial management principles. Such financial services card would preferably be issued and administered in a manner consistent with prior art merchant practices, taking into account necessary consideration to assure Shari'ah compliance. Such financial services card can be issued by conventional banks and issuers within a parallel Shari'ah compliant billing and data processing administrative model that is consistent with prior art practices. Such financial services card would provide increases in fiscal convenience to its users by effectively bridging the religious, cultural and ‘credit’ criteria “gap” inherent in Islamic consumer use of conventional credit cards. Such financial services card would expand the potential consumer customer base of card issuers to be inclusive of the Islamic consumer market which has been largely ignored under present issuance and administration practices.

Such financial services card would make compatible what have customarily been viewed as vastly divergent and conflicting consumer practices and philosophies—those being, the faith-based, religious considerations of Islamic consumers under recognized Shari'ah guidelines, and the traditional credit practices which form the cornerstone of conventional banking. Such financial services card would afford an Islamic consumer financial services options comparable to those available to consumers in the conventional markets. Such financial services card would promote the freer flow of Islamic consumer capital into the marketplace by providing a means for increased consumer buying power today in expectation of retirement of such expenditures over time. Such financial services card would give the Islamic consumer the opportunity to access capital not otherwise available upon demand without concern for violating religious principles which the consumer holds dear, thus affording certain previously unavailable liquidity to the consumer.

### SUMMARY OF THE INVENTION

A financial services card in accordance with the principles of the present invention can be utilized in the operation of consumer purchases and payments in a manner consistent with conventional credit card processing while observing Shari'ah compliant financial principles, inclusive of but not necessarily limited to the avoidance of riba. A financial services card in accordance with the principles of the present invention bridges the religious, cultural and credit criteria “gap” inherent in Islamic consumer use of conventional credit cards. A financial services card in accordance with the principles of the present invention makes compatible what have customarily been viewed as vastly divergent and conflicting consumer practices and philosophies such that an Islamic consumer is afforded financial services options comparable to those available to consumers in the conventional markets.

A financial services card in accordance with the principles of the present invention is issued and administered in a manner consistent with prior art merchant practices such that it may be assimilated by existing conventional credit card merchant processing platforms and transaction acquisition practices while taking into account necessary considerations to assure Shari'ah compliance. A financial services card in accordance with the principles of the present invention can be issued by existing conventional banks and issuers within a parallel Shari'ah compliant billing and data processing administrative model that is compatible with prior art practices. A financial services card in accordance with the present invention promotes the freer flow of Islamic consumer capital into the marketplace by providing a means for increased consumer buying power today in expectation of the consumer's reimbursement of such expenditures over time. A financial services card in accordance with the present invention gives the Islamic consumer the opportunity to access capital not otherwise available without concern for violating religious principles which the consumer holds dear, thus affording certain increased liquidity to the consumer.

In accordance with the principles of the present invention, a financial services card membership organization or cooperative is created consisting of select and qualified Islamic consumers. The cardholder membership base is granted certain access to the financial services card issuer's aggregated available capital as a function of membership. A membership rating system is established based in part on the status and good standing of each member's respective membership with the card issuer. This provides the means to regularize a methodology for governing member access to aggregate capital availed and pooled by the financial services card issuer. Capital is availed to the membership base in a manner consistent with the application of a set of procedures that quantify membership dues payment histories, general payment histories, member income, and the amount of capital deployed and outstanding from the issuer's aggregate capital base. Each respective member can deploy permitted capital from the card issuer's capital pool and subsequently reimburse such capital as and when convenient; provided, the membership status of the respective consumer has remained in good standing. Voluntary capital contributions are allowed by the membership to the card issuer's available capital base. The voluntary capital contributions may permit the contributing members to participate in an agreed, pro rata share of membership dues collected while member contributions are actively engaged and/or deployed pursuant to the terms of membership or of Shari'ah compliant yields generated upon aggregated pooled capital. Lastly, a financial services card in accordance with the principles of the present invention provides for Islamic consumers to access capital for discretionary purposes via a membership structure in a far more manageable, efficient and Shari'ah compliant manner than present practices permit.

### BRIEF DESCRIPTION OF THE DRAWINGS

FIG. 1 is a methodological schematic overview of a consumer-based capital management cooperative in accordance with the principles of the present invention.

FIG. 2 is a methodological schematic showing details of a consumer/member payment processing, account debit, and settlement transaction in accordance with the principles of the present invention.

FIG. 3 is a methodological schematic showing capital contribution features and pro rata membership/yield distributions payable to the contributing member in accordance with the principles of the present invention.

FIG. 4 is a methodological schematic showing Shari'ah compliant ‘member compliance’ mechanisms applicable in a member default in accordance with the principles of the present invention.

### DETAILED DESCRIPTION OF THE INVENTION

A financial services card in accordance with the principles of the present invention effectively overcomes well-recognized obstacles to the Islamic consumer's use of credit card-like instruments for conducting payment or transaction-based business. When combined with tried-and-true conventional credit card processing and a Shari'ah compliant infrastructure designed to exclude the payment or collection of forbidden profits (interest, or riba), a financial services card in accordance with the principles of the present invention enables the issuance of a Shari'ah (Islamic) compliant financial services card for consumer use in a manner comparable to conventional merchant-based credit card payment transactions. This Shari'ah (Islamic) compliant financial services card can be acquired openly by qualified Islamic consumers as the basis to avail supplemental and discretionary capital access to such Islamic consumers.

A financial services card in accordance with the principles of the present invention starts with the creation of a pool of capital as aggregated by the card issuer within the context of a capital management cooperative for pre-authorized deployment by certain qualified Islamic consumers. A financial services card of the present invention enables the allocation of capital by qualified and registered Islamic consumers as members of a capital management cooperative via the utilization of a financial services card. Under the terms of cooperative membership and via the maintenance of good membership standing by each cooperative member as a financial services card holder, a financial services card of the present invention establishes a standardized foundation upon which Islamic consumers may access capital for discretionary use in a comparable manner and with equal ease as available to conventional credit card holders.

Moreover, a financial instrument in accordance with the principles of the present invention provides a basis for the availing of capital on a revolving basis by Islamic consumers which, to date, has not existed in a Shari'ah compliant environment. Specifically, by employing a financial serves card of the present invention, the consumer can access capital otherwise not available to them, deploy that capital to merchants or vendors that are qualified to accept the financial services card, reasonably permit amounts accessed to remain outstanding for an extended period of time provided certain minimum payments are maintained, and benefit from certain yield generating opportunities upon the payment of capital contributions in excess of amounts due or outstanding to the cooperative.

A financial services card in accordance with the principles of the present invention combines the definable and consistent nature of a traditional credit card with a fiscal structure which hinges upon certain religious edicts of Islam that in themselves are difficult for non-Islamic parties to understand and appreciate. In fact, one of these edicts seems to fly in the face of some of the conventional credit card market's most common financial practices: the prohibition of collection or payment of riba or interest in exchange for making capital available or in exchange for the deposit of funds. Such a core value beneficial combination of Islamic fiscal philosophy with non-Islamic credit mechanisms stands as the focal point of a financial services card in accordance with the principles of the present invention.

The benefits of a financial services card in accordance with the principles of the present invention, however, evidence a number of peripheral features and benefits. The financial processes that enable the operation of the financial services card are unique in the retail banking, credit card industry, and financial markets, and serve to highlight the technical complexities of accomplishing the implementation of these features in what is considered a Shari'ah (Islamic) compliant manner. For example, the following are features and benefits of a financial services card in accordance with the principles of the present invention:
The present invention can be applied in the same manner and based upon the same processing platforms and transaction acquisition practices as already are in widespread merchant use in the conventional credit card industry while still maintaining the moral integrity inherent in Shari'ah compliant financial practices.
The present invention can be utilized as a mechanism for instructing the allocation of capital on behalf of the card holder as a regulated member of a capital management cooperative rather than as a means of manifesting conventional debt or credit line obligations.
The present invention stems from a card issuer that is organized in a manner comparable to a financial cooperative which has allocated and aggregated certain capital through its own contribution and the capital contribution of its approved and qualified members (the financial services card holders); the aggregated capital may then be applied in Shari'ah compliant investments as well as the operations of the cooperative itself, thus assuring its members of the maintenance of a Shari'ah compliant infrastructure throughout the operations process while simultaneously fiscally enhancing the liquidity available in the Islamic financial markets.
By way of certain membership covenants, the present invention can be governed under a set of procedures which reflect a standardized membership maintenance fee schedule and capital contribution policy; this process can take into account the status or standing of a respective member under the terms of membership, the amount of capital then deployed and unreimbursed by that member, the financial standing of the member both within and without the operation of the cooperative, the amounts approved for allocation by a particular member, payment and reimbursement histories pursuant to the membership requirements, and other related performance considerations.
By way of specific membership governance mechanisms, many of the prohibited practices inherent in the operation of the conventional credit card industry such as the imposition of late fees and assorted penalties are excluded from the operation of the financial services card as such practices themselves are oftentimes deemed non-compliant with Shari'ah principles.
By way of the creation of the cooperative structure as the card issuer, the cardholders are themselves considered members of the cooperative, thus are entitled to participate on a pro rata basis with the operators or managers of the cooperative as to matters of investment practices, yield generation, and interim investment earnings; provided the member has made a capital contribution to the cooperative in excess of amounts due and billed to such member by the cooperative.

The foregoing features demonstrate the advantages of a financial services card in accordance with the principles of the present invention over the conventional credit card practices. The present invention better enables an Islamic consumer to access capital for discretionary purposes which the consumer need not immediately be prepared to reimburse in full, and does so without the accrual or incurrence of riba or interest. The present invention is modeled after the generally accepted consumer credit card processes available in the conventional market, but which, by their nature and without carefully engineered adaptation, are not permissible under Shari'ah investment practices. The implementation of the present invention in the Islamic retail and consumer marketplace will produce an expanded market for the issuance of a new class of credit card-like financial services cards for subsequent use by the Islamic consumer and, therefore, will induce greater liquidity in the consumer or retail market space. This then will also indirectly increase the wholesale demand for Shari'ah compliant passive investment vehicles, thus producing greater liquidity within the institutional Islamic financial markets. When structured in accordance with the principles of the present invention, a Shari'ah compliant financial services card can enter the conventional credit card industry, through the use of complimentary transaction processing and acquisition platforms, and satisfy a long-unsatisfied need within the Islamic consumer marketplace for the type of liquidity that conventional credit card consumers have taken for granted.

A financial services card of the present invention effectively overcomes well-recognized obstacles to the Islamic consumer's use of credit card-like instruments for conducting payment or transaction-based business. As known in the art, a financial services card in accordance with the principles of the present invention can be embodied as a system cooperating with computer hardware components, and as a computer-implemented method.

### EXAMPLE

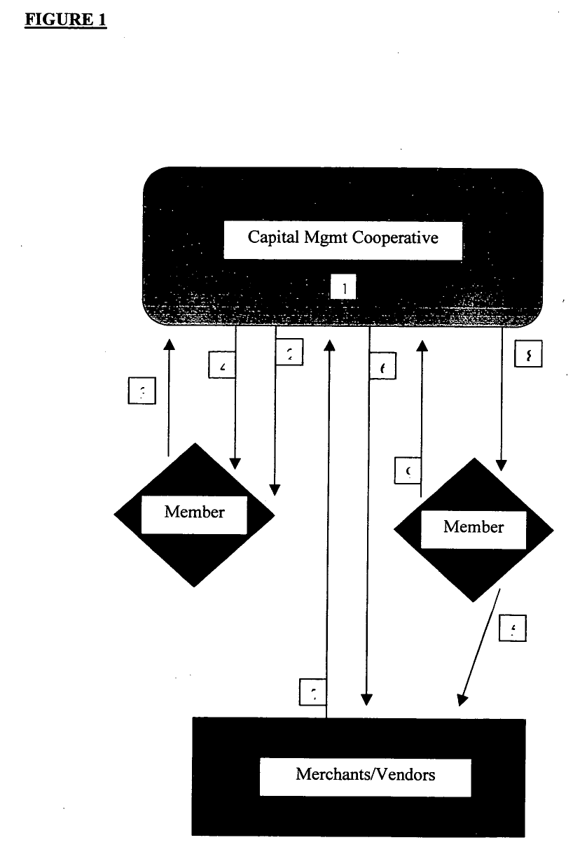

Referring to FIG. 1, a methodological schematic overview of a consumer-based capital management cooperative in which financial services cards implement membership directives as to capital deployment in accordance with the principles of the present invention is seen. A capital management cooperative is established or nominated for the purposes of issuing the financial services cards (101). The cooperative may be initially funded by either its founders or capital underwriters, although certain subsequent members may make additional capital contributions at their respective discretion. The capital held for use by the cooperative will be managed in a Shari'ah compliant manner either via interim deployment into Shari'ah compliant passive institutional investment units, Shari'ah compliant consumer/retail investment units, Shari'ah compliant savings accounts or such other Shari'ah compliant investment accounts and processes as may be deemed acceptable. The cooperative can create a document that provides the potential cooperative member as a user of the financial services card with a required description of and disclosure related to the nature of the financial services card, policies related thereto, and the operations of the cooperative (“Membership Agreement”).

The cooperative can undertake to identify potential members of the cooperative that subscribe to a specified eligibility/membership selection criteria based in part on financial standing, demographic profile, income, payment histories, and various other criteria that may be determined. The cooperative can solicit (102) such potential members to join the cooperative, profiling the terms of cooperative management and operation in the Membership Agreement. The Membership Agreement sets out terms of membership inclusive of making disclosures as to various cooperative policies which are binding upon the activities of its membership, disclosure of agreed membership maintenance fees and schedules, a description of membership rights pertaining to each respective member's rights to instruct the deployment of capital held by the cooperative, the means by which such instructions are tendered, qualified parties to whom capital may be deployed upon membership request, consequences of default under the terms of membership, and any other matters deemed of significance for disclosure by the cooperative.

Potential members that agree to join the cooperative pursuant to the terms of membership become members of the cooperative. At the discretion of the cooperative, members may be required to pay an initial capital contribution to the cooperative for the privilege of becoming a member (103). Upon acceptance of the terms of membership and the payment of an initial capital contribution, if any, the party is considered a participating member of the cooperative.

Upon the cooperative's receipt of a member's acknowledgement and acceptance of membership terms and related fee schedules, the cooperative will issue a financial services card in the name of the member (104). The financial services card constitutes the mechanism by which the member tenders its instruction or request to the cooperative for payment of an authorized amount on the member's behalf in favour of any party or merchant registered or under agreement with the cooperative to accept payment utilizing the card.

Once a member has received its financial services card and appropriately activated it, the member may present it as a means of payment to any authorized merchant or vendor in satisfaction of a payment obligation incurred by the member up to the maximum amount permitted and authorized for payment by the member from the cooperative's funds (105). Acceptance of the financial services card by a merchant/vendor will be predicated, among other things, upon that merchant/vendor's entry into a financial services card acceptance agreement with the cooperative. Presentation of a financial services card to a pre-qualified or authorized merchant/vendor in many practical respects mimics the processing of a traditional credit card with this same merchant/vendor, thereby lowering the barriers to entry into the market for the cooperative's financial services card. Although not required for the purposes of operation of the financial services card, affiliation or direct association of the cooperative with an established bank or conventional issuer can aid in facilitating acceptance of the financial services card by an array of merchant/vendors.

Upon submission of the payment request from the merchant/vendor against the merchant/vendor's acceptance of the financial services card from a member, the cooperative disburses (106) payment in favour of the merchant/vendor's designated account. As and when due, the merchant/vendor will remit (107) certain fees or surcharges due to the cooperative as consideration for payment services per an agreed upon fee schedule. Although not depicted in FIG. 1 and consistent with many conventional credit card issuer's practice, the cooperative, by agreement with the merchant/vendor, could debit fees from gross amounts paid in to the merchant/vendor at time of financial service card capital disbursements as initiated by the member.

Pursuant to the terms of membership and in accordance with an agreed membership maintenance schedule and capital contribution policy, the cooperative can periodically issue statements or invoices to its respective members (108). These statements can define maintenance fees payable and minimal capital contributions required based on the member's level of account activity, total amount of capital directed for payment by the member against the member's account, and the status and good standing of the member's membership in the cooperative, among other things. Although not required, in a preferred embodiment, the cooperative's statements could be issued monthly to its members.

Upon receipt of the periodic member account statements, each member remits (109) minimum payments required by the cooperative, or such other greater amount as the member may so determine, as the basis to maintain its cooperative membership in good standing.

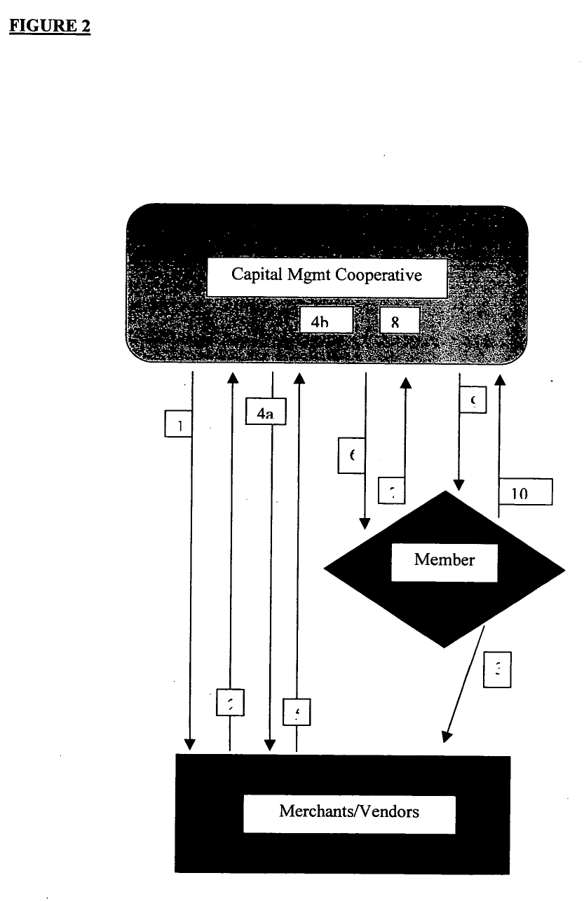

Referring now to FIG. 2, a methodological schematic showing details of member payment processing, account debit, and settlement transaction with registered merchants/vendors over two billing cycles, illustrating a rollover of member balances mechanism in accordance with the principles of the present invention is seen. As a predicate to the processing of the financial services card, the cooperative pre-qualifies and registers select merchants/vendors for acceptance of the cooperative's financial services card pursuant to a merchant agreement (“Merchant Agreement”) (201). The Merchant Agreement sets out the terms and conditions of payment processing of the financial services card inclusive of a schedule of fees and charges payable to the cooperative as the financial services card issuer, among other things. Although not required, in one embodiment of the present invention, financial services card acceptance and processing can occur in a manner consistent with established practices and norms of the conventional credit card industry. Thus, in this embodiment the card acceptance platform or the transaction acquisition methodology to be utilized by the merchant/vendor does not deviate from existing equipment and software requirements already maintained by most merchants/vendors that are equipped to accept conventional credit cards. To enable the merchant/vendor to accept the financial services card, the merchant/vendor executes (202) the Merchant Agreement with the cooperative.

A member may thereafter present their respective financial services card to a merchant/vendor in satisfaction of a payment obligation incurred by the member with the merchant/vendor up to the maximum amount permitted for instructed deployment under that particular member's account with the cooperative (203). The merchant/vendor accepts the card for processing. In response to its receipt of the merchant/vendor's request for payment on behalf of the member as the financial services cardholder, the cooperative tenders payment (204a) on behalf of its member. Simultaneous with the distribution of payment in favour of the respective merchant/vendor, the cooperative records (204b) an amount equal to the payment tendered against the member's account on whose behalf payment was made. As in the prior example, as and when due, the merchant/vendor remits (205) periodic fees due to the cooperative as consideration for the cooperative payment services per an agreed schedule. Again, although not illustrated in this example, the merchant/vendor may agree to have its fees debited from gross amounts paid or distributed to it b the cooperative.

Pursuant to the terms of membership and certain fee schedules and capital contribution policies set forth therein, the cooperative can periodically issue (206) statements to its members requesting payment of certain membership maintenance fees and minimal capital contributions. These payments can be based upon the member's level of account activity as recorded, the aggregate amount of capital directed for payment by the member that remains unreimbursed, and the status and good standing of the member in the cooperative, among other things. Although the member may elect to pay the entire amount requested for payment by the cooperative, for the sake of our example, the member can elect to pay (207) only the minimum stated maintenance fee and capital contribution to the cooperative, leaving a balance to be carried forward to the next invoice or billing cycle on the member's account.

The cooperative receives and records (208) the total minimum payment from the member on its books. Specifically, the cooperative applies the minimum capital contribution against the aggregate total capital paid out on behalf of the member's account and credits the corresponding maintenance fee against the scheduled maintenance fee accrued on the member's account during the statement period. Assuming, again for the sake of our example, the member has not utilized its financial services card as the basis for settling any additional amounts due with qualified merchants/vendors and, thus the balance of capital disbursed on the member's account has remained static except for credits applied, the cooperative, on the next agreed billing cycle, issues (209) a statement of account to the member reflecting credits for capital contributions received and maintenance fees paid and requiring remittance of a minimum capital contribution as calculated pursuant to the cooperative's capital contribution policies and the payment of the next periodic membership maintenance fee due.

In response to receipt of the account statement, the member remits (210) minimum payments required by the cooperative, or such other greater amount as the member may so determine, as the basis to maintain their membership in good standing. Although not illustrated here, in the event the member fails to remit the minimum required payments to the cooperative in a timely manner, at the option of the cooperative, membership privileges may be temporarily or permanently revoked or an alternative membership maintenance fee schedule may be invoked.

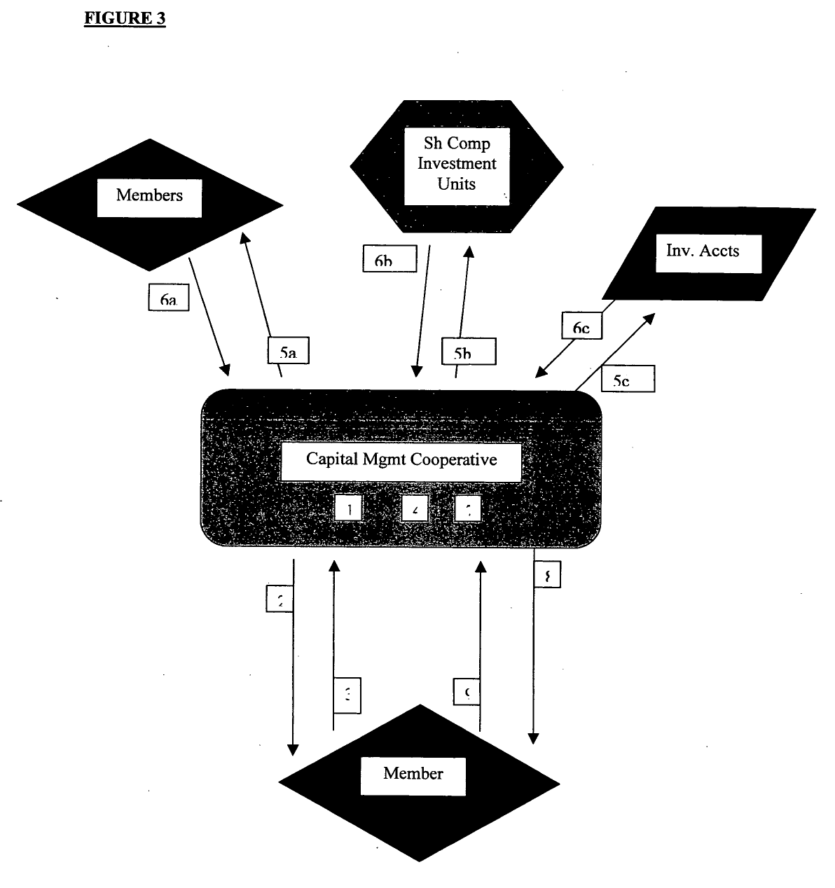

Referring now to FIG. 3, a methodological schematic showing capital contribution features and pro rata membership/yield distributions payable to the contributing member in accordance with the principles of the present invention is seen. A cooperative can be established for the purposes of issuing the financial services cards (301). The cooperative may be initially funded by either its founders or capital underwriters, although certain subsequent members may make additional capital contributions at their respective discretion. The capital held for use by the cooperative will be managed in a Shari'ah compliant manner either via interim deployment into Shari'ah compliant passive institutional investment units, Shari'ah compliant consumer/retail investment units, Shari'ah compliant savings accounts or such other Shari'ah compliant investment accounts and processes as may be deemed acceptable.

For the sake of the example, the cooperative issues (302) a periodic billing statement to a member, which identifies the membership maintenance fee due, plus a minimum capital contribution required to offset amounts paid out by the cooperative on behalf of that specific member. Upon receipt of the statement from the cooperative, the member can remit (303) full payment of the required capital contribution plus the membership maintenance fee as set out in the statement. Additionally, however, the member can elect to remit an amount in excess of the amounts billed (up to the maximum amount permitted for each respective member's capital contribution under the terms of membership) with such amount to be credited in favor of the member's account for application toward future amounts payable to the cooperative on behalf of the member or for interim management as part of the cooperative's aggregate capital pool.

The amount of capital contribution in excess of the amounts reimbursable or otherwise due on behalf of the member's account is credited (304) to the member's account. Although the present invention may not require the following, in one embodiment of the present invention, once a capital contribution has been credited to a member's account, constituting an overage to the required capital contribution due, the amount of the capital contribution overage can thereafter be subject to pro rata participation in yield derived from the subsequent application or investment of that amount of overage as part of the cooperative's capital pool. For example, the member may generate and could receive a pro rata yield calculated on such excess contribution amount as generated resultant from the cooperative's deployment thereof into various elective or discretionary Shari'ah compliant investments as initiated by the cooperative; provided, however, that the cooperative received or generated income, gain or yield during the term for which the overage was credited to the respective member's account.

As part of the discretionary deployment and investment practices of the cooperative's aggregated capital pool, the cooperative can avail all or any portion of its available capital toward payments to be distributed pursuant to the customary operation of the cooperative as defined under the terms of membership in support of other members' payment instructions. The payment instructions can be instigated via such members' utilization of their respective financial services cards as issued by or in association with the cooperative (305a), the acquisition of and investment in certain Shari'ah compliant passive institutional investment units or consumer/retail investment units which may be bought, sold and traded at the discretion of the cooperative (305b), and the deposit of funds to qualified Shari'ah compliant investment accounts as maintained by acceptable banks or other financial institutions (305c).

Pursuant to the cooperative's interim capital management strategy and assuming that the cooperative's aggregated capital pool successfully generated an amount of yield through its interim capital management activities, the cooperative may periodically collect certain fees or yield upon their respective investments. Specifically, the cooperative can: accept (306a) customary membership maintenance fees, scheduled capital contributions and/or other fees from its members, resulting in the generation of income to the cooperative; periodically collect (306b) certain dividend-based or trade profits arising from the Shari'ah compliant passive investment units; and/or earn (306c) certain minimum depository or investment yields arising from the cooperatives utilization of select Shari'ah compliant investment accounts.

Assuming the receipt of earnings, profits or yield as described, the cooperative can allocate (307) a pro-rata share of such amounts for the benefit of the respective member's account who had remitted the excess capital contribution, plus reimburse such capital contribution to that account as agreed under the Membership Agreement. As with any Shari'ah compliant investment or capital management function, yield, earnings or return are not guaranteed and, as a result, the member may not receive any pro rata share of yield as there may have been no yield generated during the period for which the member's excess capital contribution was on account and, therefore, no yield payment attributable to the member.

Dependent on the respective member's activities during the most recent statement cycle, the cooperative can issue its customary billing statement (308) reflecting authorized payments effectuated by that member using the member's financial services card, membership maintenance fees due, and any and all pro rated yield, earning or profits arising from the excess capital contribution that had been credited to the member's account in the prior billing cycle. Against receipt of the billing statement, the member remits (309) minimum payments as and when required by the cooperative, or such other greater amount as the member may so determine, as the basis to maintain its membership in good standing.

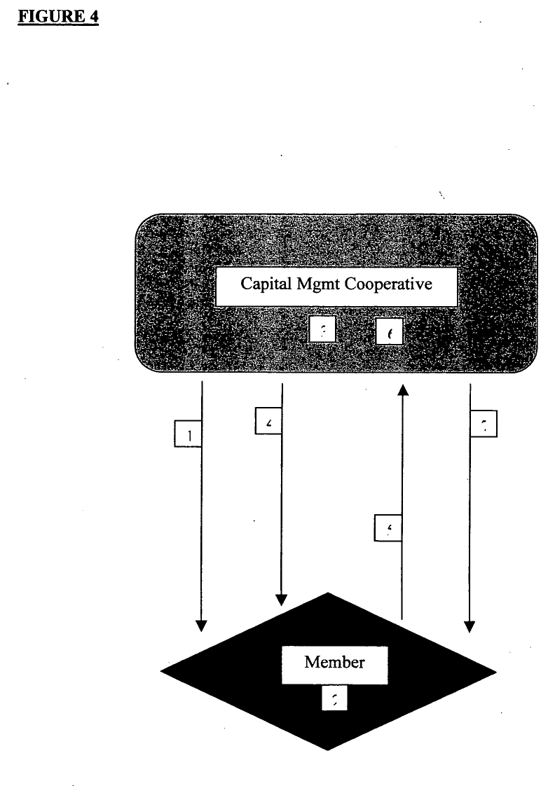

Referring now to FIG. 4, a methodological schematic showing Shari'ah compliant ‘member compliance’ mechanisms applicable in a member default in accordance with the principles of the present invention is seen. This example assumes that the member has engaged in making payments/allocations of capital utilizing the financial services card and has accrued a balance requiring some scheduled and agreed payment thereon.

Pursuant to the terms of membership and in accordance with an agreed membership contribution and maintenance schedule, the cooperative can periodically issue (401) billing statements to its members calling for remittance of scheduled membership maintenance fees and minimal capital contributions required based upon, for example, the member's level of account activity, the aggregate amount of capital directed for payment by the member which remains unreimbursed, and the status and good standing of the member in the cooperative, among other things. For the sake of this example, the member has failed to remit (402) scheduled fees and minimum capital contributions in favour of the cooperative, leaving the member's account unpaid and constituting a default.

The cooperative, upon failing to receive the scheduled minimum amounts when due, on behalf of itself and the other members of the cooperative takes (403) certain measures designed to induce compliance by the member and the payment of amounts due. Specifically, the cooperative may suspend membership privileges to the defaulted member by temporarily blocking use of the defaulted member's financial services card, escalate the membership maintenance fees to an alternate scale such that the fees payable reflect a member account that is not in good standing with the cooperative, issue various notices of membership default or take similar actions designed to induce payment or member compliance with the terms of membership. The cooperative will not, however, apply late fees or penalties calculated on amounts then unreimbursed on the member's account as such customarily are not consistent with Shari'ah compliant practice.

Assuming, again for the sake of example, that the member failed to remedy its membership default by remittance of amounts due prior to the next billing cycle, the cooperative can issue (404) its next periodic billing statement reflecting that the member's account is not in good standing and requesting full or partial payment of capital paid out by the cooperative on behalf of the member's account plus an increased membership maintenance fee reflective of scales or fee schedules applicable to member accounts then not in good standing. Depending on the duration that the member account remains in poor standing, the cooperative may elect to permanently revoke membership privileges and undertake collection proceedings for amounts tendered on the member's behalf.

Upon receipt of certain notices or the undertaking of certain permitted actions by the cooperative, the member can remit (405) certain minimum payments required by the cooperative, or such other greater amount as the member may so determine. Upon receipt of minimum amounts due, the cooperative may elect (406) to restore all card privileges, upgrade the member's account to one of good standing, thus reducing the membership maintenance scale/schedule as had been potentially previously increased, and the member may continue utilizing the financial services card as intended pursuant to the terms of membership. Thereafter, the cooperative can resume (407) its relationship with the member and issue a periodic billing statement during the next billing cycle reflective of permitted and authorized activities on the member's account

Thus, a financial services card in accordance with the principles of the present invention encompasses certain specific features which make it new and innovative in the Islamic consumer banking market and amongst conventional credit card products. A financial services card in accordance with the principles of the present invention makes tangible the philosophical beliefs of Islam within a framework that is customarily relegated to traditional or conventional credit card functions which in themselves fall well outside the general scope of activities permissible under Shari'ah compliant financial guidelines.

While the invention has been described with specific embodiments, other alternatives, modifications and variations will be apparent to those skilled in the art. Accordingly, it will be intended to include all such alternatives, modifications and variations set forth within the spirit and scope of the appended claims.

What is claimed is:

1. A method of creating a financial instrument comprising:
creating a financial services card membership organization;
the organization issuing a financial services card;
aggregating capital pooled by the financial services card issuer;
granting certain access to the aggregated capital as a function of membership;
establishing a membership rating system;
each respective member deploying permitted capital from the capital pool; and
each respective member subsequently reimbursing such capital.

2. The method of creating a financial instrument of claim 1, wherein the step of creating a financial services card membership organization comprises creating a cooperative.

3. The method of creating a financial instrument of claim 1, wherein the step of establishing a membership rating system comprises establishing a membership rating system based on the financial status of each member and the standing of each member's membership with the card issuer.

4. The method of creating a financial instrument of claim 1, further including availing capital to the membership based on a set of procedures that quantify membership dues payment histories, general payment histories, member income, and the amount of capital deployed and outstanding from the issuer's aggregate capital base pursuant to the directives of each respective member.

5. The method of creating a financial instrument of claim 1, further including allowing voluntary capital contributions by the membership to the card issuer's available capital base in amounts in excess of capital deployed and outstanding on behalf of the contributing member's account.

6. The method of creating a financial instrument of claim 5, further including subjecting the amount of the capital overage to pro rata participation in yield derived from the investment of that amount of overage in assorted Shari'ah compliant investment activities or operations that are undertaken as part of the issuer's aggregate capital pool.

7. The method of creating a financial instrument of claim 1, further including applying processing platforms in generally the same manner and based generally upon the same processing platforms as is in use in the conventional credit card industry while maintaining Shari'ah compliant financial practices.

8. The method of creating a financial instrument of claim 7, further including applying merchant/vendor transaction acquisition practices in generally the same manner and via a utilization of the same transaction acquisition processing equipment as is in use in the conventional credit card industry while maintaining Shari'ah compliant financial practices

9. The method of creating a financial instrument of claim 1, further including managing capital held for use by the organization in a Shari'ah compliant manner.

10. The method of creating a financial instrument of claim 1, further including submitting a payment request from a merchant/vendor to the organization against the merchant/vendor's acceptance of the financial services card from a member.

11. The method of creating a financial instrument of claim 10, further including establishing and pre-qualifying merchants/vendors for acceptance of the financial services card pursuant to a standardized merchant agreement governing the terms of financial services card transaction acquisition.

12. The method of creating a financial instrument of claim 1, further wherein the step of each respective member subsequently reimbursing such capital comprises establishing a schedule of minimum capital contributions payable by a member based in part upon that member's respective account activity and the volume of capital deployed by the cooperative on the member's behalf.

13. The method of creating a financial instrument of claim 1, further including each member paying periodic membership fees to the cooperative pursuant to a standardized schedule in exchange for the privilege of membership.

14. The method of creating a financial instrument of claim 13, further including basing the membership fees payable from each member upon the respective member's level of account activity, total amount of capital directed for payment by the member against the member's account, the status and good standing of the member's membership in the organization, and combinations thereof.

15. A method of creating a financial instrument comprising:
applying processing platforms in generally the same manner and based generally upon the same processing platforms as in use in conventional credit card industry while maintaining Shari'ah compliant financial practices;
issuing a financial services card;
instructing the allocation of capital on behalf of the card holder rather than deploying capital as a means of manifesting credit;
applying the aggregated capital of the issuer to Shari'ah compliant investments as well as the operations of the financial services card issuer itself; and
excluding prohibited or non-Shari'ah compliant practices of the conventional credit card industry from the operation of the financial services card.

16. The method of creating a financial instrument of claim 15, further including organizing the financial services card issuer as a financial management cooperative which has aggregated capital.

17. The method of creating a financial instrument of claim 16, further including governing cooperative operations under a set of procedures which reflect a standardized membership maintenance fee schedule and capital contribution policy.

18. The method of creating a financial instrument of claim 15, further including defining maintenance fees payable and capital contributions due from members.

19. The method of creating a financial instrument of claim 18, further including basing the fees payable from each member upon the member's level of account activity, total amount of capital directed for payment by the member against the member's account, the status and good standing of the member's membership in the cooperative as the financial services card issuer, and combinations thereof.

20. The method of creating a financial instrument of claim 15, further including establishing a membership rating system.

21. The method of creating a financial instrument of claim 20, wherein the step of establishing a membership rating system comprises establishing a membership rating system based on the status of each respective member's membership with the card issuer, among other criteria defining the financial standing of the member.

22. The method of creating a financial instrument of claim 15, further including allowing members to make voluntary capital contributions to the card issuer's available capital base in excess of gross amounts outstanding or deployed by the card issuer/cooperative on behalf of a respective member's account.

23. The method of creating a financial instrument of claim 22, further including subjecting any amount of capital contribution overage to pro rata participation in yield derived from the investment of that amount of overage as part of the interim investment operation of the cooperative's capital pool.

24. The method of creating a financial instrument of claim 15, further including submitting a payment request from a merchant/vendor to the financial services card issuer against the merchant/vendor's acceptance of the financial services card from a member.

25. A method of creating a financial instrument comprising:
establishing a consumer-based capital management organization;
managing capital held for use by the organization in a Shari'ah compliant manner;
issuing a financial services card in the name of a member;
submitting a payment request from a merchant/vendor to the organization against the merchant/vendor's acceptance of the financial services card from a member;
the organization disbursing payment in favour of the merchant/vendor's designated account;
the organization attributing payments made in favour of a merchant/vendor against the account of the respective member from whom payment instructions were tendered via presentment of the financial services card to a merchant/vendor; and
defining fees payable from members.

26. The method of creating a financial instrument of claim 25, further wherein the step of defining fees payable from members comprises defining membership maintenance fees payable and minimum capital contributions due from members based upon certain membership standards and account activities/profiles.

27. The method of creating a financial instrument of claim 25, further including basing the fees payable from the member upon the member's level of account activity, total amount of capital directed for payment by the member against the member's account, the status and good standing of the member's membership in the organization, and combinations thereof.

28. The method of creating a financial instrument of claim 25, further wherein the step of defining fees payable from members comprises establishing a membership rating system.

29. The method of creating a financial instrument of claim 28, wherein the step of establishing a membership rating system comprises establishing a membership rating system based on the status of membership with the card issuer.

30. The method of creating a financial instrument of claim 25, further including availing capital to the membership base based on the group comprising membership dues payment histories, general payment histories, member income, the amount of capital deployed and outstanding from the issuer's aggregate capital base pursuant to the directives of each respective member, and combinations thereof.

31. The method of creating a financial instrument of claim 25, further including allowing voluntary capital contributions by the membership to the card issuer's available capital base in amounts in excess of aggregate issuer capital deployed in payment on behalf of the respective member from whom the voluntary capital contribution arises.

32. The method of creating a financial instrument of claim 31, further including subjecting the amount of the capital overage to pro rata participation in yield derived from the investment of that amount of overage as part of the card issuer's capital pool.

33. The method of creating a financial instrument of claim 25, further including applying processing platforms and merchant/vendor transaction acquisitions in generally the same manner and based generally upon the same processing platforms and practices as in use in the conventional credit card industry while maintaining Shari'ah compliant financial practices.

34. The method of creating a financial instrument of claim 25, further wherein the step of establishing a consumer-based capital management organization comprises establishing a cooperative.

35. A method of creating a financial instrument comprising enabling the issuance of a Shari'ah (Islamic) compliant financial services card for consumer use in a manner comparable to conventional merchant-based credit card payment transactions.

36. A method of creating a financial instrument comprising enabling a consumer to access capital for discretionary purposes which the consumer need not immediately be prepared to reimburse in full, without the accrual or incurrence of riba or interest.
